(19) United States
(12) Patent Application Publication
(10) Pub. No.: US 2021/0224272 A1
(43) Pub. Date: Jul. 22, 2021

(54) METHOD, DEVICE, COMPUTER APPARATUS, AND STORAGE MEDIUM FOR STORING DATA

(71) Applicant: PING AN TECHNOLOGY (SHENZHEN) CO. LTD., Shenzhen, Guangdong (CN)

(72) Inventor: Wenqin ZHONG, Shenzhen, Guangdong (CN)

(73) Assignee: PING AN TECHNOLOGY (SHENZHEN) CO. LTD., Shenzhen, Guangdong (CN)

(21) Appl. No.: 16/097,783

(22) PCT Filed: Oct. 31, 2017
(86) PCT No.: PCT/CN2017/108463

§ 371 Date: Oct. 30, 2018

(30) Foreign Application Priority Data
Sep. 15, 2017 (CN) 201710833247.5

(51) Int. Cl. G06F 16/2458; G06F 7/16; G06F 16/248

(52) U.S. Cl. CPC G06F 16/2474; G06F 16/248; G06F 7/16

(57) ABSTRACT

A method of storing data, a device, a computer apparatus, and a storage medium relate to data processing technical field. The method of storing data comprising: acquiring call data obtained in a unit time period; preprocessing the call data based on a preset processing rule according to information carried by the call data; and storing a pre-processed call data, a start time and an end time of the unit time period simultaneously.

### CROSS REFERENCE TO RELATED APPLICATIONS

This application claims priority to Chinese Patent Application No. 2017108332475, entitled “method, device, computer apparatus, and storage medium for storing data”, filed Sep. 15, 2017, the contents of which are expressly incorporated herein by reference in its entirety.

### TECHNICAL FIELD

The present disclosure relates to data processing technology, and more particularly relates to a method for storing data, a device, a computer apparatus, and a storage medium.

### BACKGROUND

At present, a processing flow of the monitoring data is as follow. After being received, the monitoring data is directly stored in a database. When the monitoring data needs to be processed or queried, a corresponding data is queried in the database according to conditions input by a user. And then calculating, classifying, and counting, etc. processes are performed on the queried data.

This currently processing method is practical for a small amount of data, but it is not suitable for massive data. When the amount of the monitoring data is large, for example, when tens of millions or even hundreds of millions of data need to be processed every day, if the received data is directly stored in the database, when searching for a data in the database to meet a specific requirement, the amount of data that needs to be accessed is very large. When the massive data in the database is frequently accessed, it, on one hand, increases a load on the database, and on the other hand, makes data processing inefficient.

### SUMMARY

According to various embodiments of the present disclosure, a method of storing data, a device, a computer apparatus, and a storage medium are provided.

A method of storing data includes:

acquiring call data obtained in a unit time period;

preprocessing the call data based on a preset processing rule according to information carried by the call data; and

storing a pre-processed call data, a start time and an end time of the unit time period simultaneously.

A device of storing data includes:

a data acquiring module configured to acquire call data obtained in a unit time period;

a preprocessing module configured to preprocess the call data based on a preset processing rule according to information carried by the call data; and

a storing module configured to store the preprocessed call data, a start time and an end time of the unit time period simultaneously.

A computer apparatus includes one or more processors, and a memory storing computer-executable instructions, which, when executed by the one or more processors cause the one or more processors to perform steps including:

acquiring call data obtained in a unit time period;

preprocessing the call data based on a preset processing rule according to information carried by the call data; and

storing a pre-processed call data, a start time and an end time of the unit time period simultaneously.

At least one non-transitory computer-readable medium includes computer-executable instructions, which, when executed by at least one processor, cause the at least one processor to perform steps including:

acquiring call data obtained in a unit time period;

preprocessing the call data based on a preset processing rule according to information carried by the call data; and

storing a pre-processed call data, a start time and an end time of the unit time period simultaneously.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

To illustrate the technical solutions according to the embodiments of the present invention or in the prior art more clearly, the accompanying drawings for describing the embodiments or the prior art are introduced briefly in the following. Apparently, the accompanying drawings in the following description are only some embodiments of the present invention, and persons of ordinary skill in the art can derive other drawings from the accompanying drawings without creative efforts.

FIG. 1 is a flowchart illustrating a method of storing data in accordance with an embodiment of the present disclosure;

FIG. 2 is a flowchart illustrating a method of storing data in accordance with another embodiment of the present disclosure;

FIG. 3 is a flowchart illustrating a method of storing data in accordance with still another embodiment of the present disclosure;

FIG. 4 is an exemplary block diagram of a device of storing data in accordance with an embodiment of the present disclosure; and

FIG. 5 is a block diagram of a computer apparatus in accordance with an embodiment.

### DETAILED DESCRIPTION OF THE EMBODIMENTS

In order to make the objects, technical solutions and advantages of the present disclosure more comprehensible, the present disclosure will be further described in detail with reference to the accompanying drawings and embodiments. It should be understood that the specific embodiments described herein are only used to explain the present disclosure, and are not intended to limit the present disclosure.

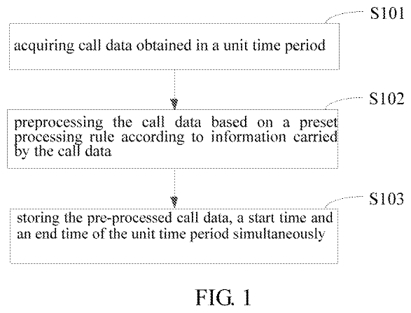

FIG. 1 is a flowchart illustrating a method of storing data according to an embodiment of the present disclosure. Hereinafter, a method of storing data according to an embodiment of the present disclosure is described in detail with reference to FIG. 1. The method can be applied to a server, as well as a terminal device. Referring to FIG. 1, the method of storing data includes the following steps S101 to S103.

In step S101, call data obtained in a unit time period is acquired.

According to an example of the embodiment, the aforementioned call data can be a generated or received call data. The source of the call data can be of two types, that is, the call data generated by an application end or a local end itself, or the call data transmitted from other devices on a peer end as well. When the local end needs to obtain a data source from other devices, such as accessing a picture, a video, and the like on a server, it is required to send a call request to a corresponding device, and a data in a network protocol format generated according to the call request can be the call data in the step S101. When other devices need to access a resource of the local end or require a response of the local end, they may send a call request (in a form of call data) to the local endcall data. The call data correspondingly received by the local end can also be the call data in the step S101.

In one embodiment, the unit time period is set by writing in advance via a programmer, and a length of the unit time period can be determined according to the throughput of data processing in a system. When the amount of data that needs to be processed corresponding to the system is very large, the unit time period can be set to be slightly shorter. Conversely, when the amount of data that needs to be processed corresponding to the system is not large, the unit time period can be set to be slightly longer. As an alternative, the unit time period can be set to be one minute.

In one of the embodiments, a time length of the unit time period is shorter than a time length temporarily stored by the application end.

In this embodiment, an acquisition of the call data is performed in units of unit time periods, for example, according to a using scenario A of the present embodiment, when the unit time period is 1 minute, within 10 minutes, the application end will acquire the call data obtained by the application end in the first minute, then in the second minute, in the third minute, . . . , in the tenth minute.

In step S102, the call data is preprocessed based on a preset processing rule according to information carried by the call data.

The call data, presented in the format of the network protocol, such as a data message or a data frame, carry information specified by the corresponding network protocol, which is an actually expressed meaning of a binary code stored in each field in the call data, such as a source IP address, a destination IP address, a user protocol, a message length and the like, including information that can be used for counting call results, such as the destination IP address, a status code indicating whether a requested data is successfully transmitted, and the like.

In this embodiment, a call result of the call data, for example, the data message transmitted in a specific protocol format, can be set differently according to requirements of querying, counting, and the like of the database in a later stage. For example, when a call success rate is required to be counted in an actual use, the call result here can be a counted success rate of a call relation corresponding to the call data. When it is required to query the number of times that the application end or the local end device initiate a request in the later stage, the call result can be a counted number of times that the application end initiates the request. When it is required to query the number of times that the same peer end device is called in the later stage, the call result here can be a counted number of times that a callee device corresponding to the same callee identifier is called, etc.

According to an example of the embodiment, the step S102 is: preprocessing the call data based on the preset processing rule according to the information carried by the call data in units of the aforementioned unit time periods.

Continuing with the aforementioned using scenario A, each time when the call data is acquired within the aforementioned unit time period, the call result of the acquired call data is counted. When the call data obtained by the application end is acquired in the first minute, the call result of this batch of call data is counted, and so on, when the call data obtained by the application end is acquired in the tenth minute, the call result of the tenth batch of call data is counted.

In step S103, the preprocessed call data, a start time and an end time of the unit time period are stored simultaneously.

In this embodiment, the storage unit in step S103 is also the aforementioned unit time period, that is, the counted call result is stored in units of unit time periods.

According to an example of the embodiment, the method of storing data further includes: splitting the acquired call data into a plurality of tasks in units of call relations, adding the tasks into the queue, and then enabling multiple threads to simultaneously process the tasks in the queue, thereby speeding up the processing speed of data.

In the obtained call data, different call data may carry the same caller identifier and callee identifier, however, call timestamps thereof are generally different, therefore a call relation can be uniquely represented by using the caller identifier, the callee identifier, and the call timestamp. The aforementioned information includes the caller identifier, the callee identifier, and the call timestamp. The method of storing data further includes: acquiring the caller identifier, the callee identifier, and the timestamp carried by the call data; and determining the call relation uniquely according to the caller identifier, the callee identifier, and the call timestamp.

In this embodiment, prior to storing the data, the data is preprocessed in units of time periods according to requirements of subsequent queries, and the preprocessed results and corresponding unit time are simultaneously stored, so that when it is required to query or calculate in the later stage according to the call data stored in the database, it only requires to simply combine the call result stored in the unit time period without accessing all the data stored in the large database again, so as to achieve the goal of improving the data processing efficiency, therefore shortening the time of data query and data processing.

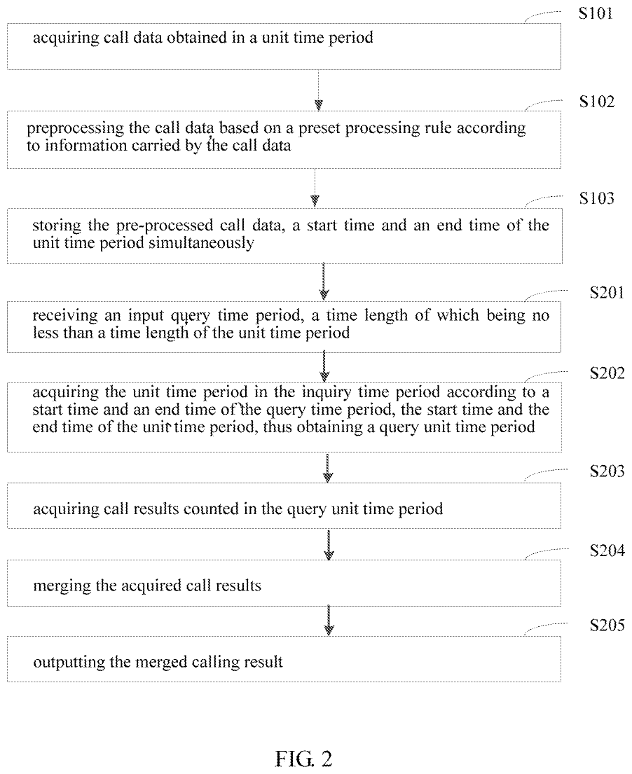

FIG. 2 is a flowchart of a method of storing data according to another embodiment of the present disclosure. Hereinafter, a method of storing data according to another embodiment of the present disclosure is described in detail with reference to FIG. 2. As shown in FIG. 2, on the basis that the method includes the aforementioned steps S101 to S103, it further includes the following steps S201 to S205.

In step S201, an input query time period is received, and a time length of the query time period is no less than a time length of the unit time period.

In this embodiment, the aforementioned query time period is generally input by a programmer or other user, and the user can query the call result within a time interval that is to be searched by inputting the query time period. In order to avoid the system from making an error in the query, the time length of the query time period is required to be greater than or equal to the time length of the unit time period.

In step S202, the unit time period in the inquiry time period is acquired according to a start time and an end time of the query time period, the start time and the end time of the unit time period, thus obtaining a query unit time period.

According to a using scenario of the embodiment, for example, continuing with the aforementioned using scenario A, when the start time of the query time period of the data is 9:00 and the end time of the input query time period is 9:10, the corresponding query unit time periods that can be obtained are as follow: 9:00 to 9:01, 9:01 to 9:02, 9:02 to 9:03, 9:03 to 9:04, 9:04 to 9:05, 9:05 to 9:06, 9:06 to 9:07, 9:07 to 9:08, 9:08 to 9:09, and 9:09 to 9:10.

In step S203, call results counted in the query unit time period are acquired.

For example, continuing with the aforementioned using scenario A, the call results counted within the aforementioned time periods 9:00 to 9:01, 9:01 to 9:02, 9:02 to 9:03, 9:03 to 9:04, 9:04 to 9:05, 9:05 to 9:06, 9:06 to 9:07, 9:07 to 9:08, 9:08 to 9:09, and 9:09 to 9:10 are respectively acquired.

In step S204, the acquired call results are merged.

For example, continuing with the aforementioned using scenario A, the counted call results within the aforementioned time periods 9:00 to 9:01, 9:01 to 9:02, 9:02 to 9:03, 9:03 to 9:04, 9:04 to 9:05, 9:05 to 9:06, 9:06 to 9:07, 9:07 to 9:08, 9:08 to 9:09, and 9:09 to 9:10 are merged to obtain the call results within 9:00 to 9:10. The merge manner can be either accumulating or averaging. For example, when the counted number of times that the device corresponding to the caller identifier is called within the time periods 9:00 to 9:01, 9:01 to 9:02, 9:02 to 9:03, 9:03 to 9:04, 9:04 to 9:05, 9:05 to 9:06, 9:06 to 9:07, 9:07 to 9:08, 9:08 to 9:09, and 9:09 to 9:10 are 30, 36, 35, 38, 40, 42, 36, 34, 32, and 45 respectively, the number of times that the device corresponding to the caller identifier is called within 9:00 to 9:10 can be obtained to be 368 by the merge processing. Accordingly, when counting the call results via the method of storing data according to the present embodiment, it only requires to perform simple accumulation or other operations on the call result within the processed unit time period, so that when performing data query or other operations in the later stage, it is not necessary to access a raw data stored in the large database, which improves the data processing efficiency and reduces the load on the database.

In step S205, the merged call result is output.

According to an example of the embodiment, an output manner of the call result can be of various types, it can be output by displaying on a display of the application end or the local end, or be transmitted to other devices to allow other devices to output, and it can also be output by voice broadcast. The specific output manner is not limited hereto.

The present embodiment provides a query method according to the method of storing data, which obtains the query unit time period by inputting the query time period, and obtains the call results within the query time period by merging the call results within the unit time periods. It is not necessary to access the raw data stored in the large database again to determine the call results, which improves the data processing efficiency and reduces the load on the database.

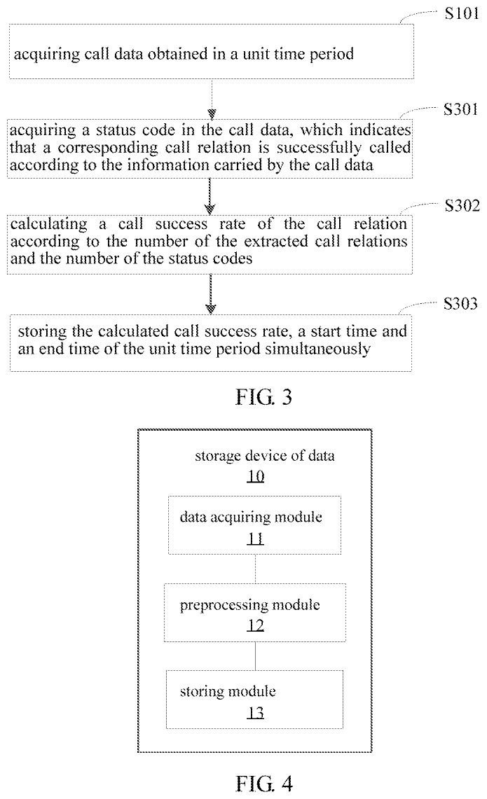

FIG. 3 is a flowchart of a method of storing data according to still another embodiment of the present application. Hereinafter, a method of storing data according to still another embodiment of the present disclosure is described in detail with reference to FIG. 3. As shown in FIG. 3, the aforementioned preprocessing includes counting a call success rate of the call data. On the basis that the method includes the aforementioned step S101, the aforementioned step S201 further includes the following steps S301 and S302.

In step S301, according to the information carried by the call data, a status code in the call data, which indicates that a corresponding call relation is successfully called in the call data, is acquired.

According to an example of the embodiment, when the status code is “00”, it indicates that the corresponding call relation is successfully called, and when the acquired status code is the other code, it indicates that the corresponding call relationship call fails. Herein, the status code may be a status code carried by the call data according to a specific protocol convention. When the method of storing data provided according to the embodiment is used in different systems, a returned status code in a protocol layer is the same, while in an application layer the user can map the status code in the protocol layer to the application layer according to the requirements and features of the system. For example, a character “Y” in the application layer can be mapped to the status code “00” and a character “N” can be mapped to other status code returned from a network layer.

In step S302, a call success rate of the call relation is calculated according to the number of the extracted call relation and the number of the status codes.

According to an example of the embodiment, the call success rate can be obtained by dividing the number of the status codes that indicate successful callings by the total number of the call relations.

The aforementioned step S103 is specifically the following step S303.

In step S303, the calculated call success rate, the start time and the end time of the unit time period are stored simultaneously.

In one of the embodiments, the aforementioned call relation is uniquely determined according to the caller identifier, the callee identifier, and the call timestamp carried in the corresponding call data. The aforementioned information includes the caller identifier, the callee identifier, and the call timestamp. The method of storing data further includes: acquiring the caller identifier, the callee identifier, and the call timestamp carried by the call data; and determining the call relation uniquely according to the caller identifier, the callee identifier, and the call timestamp.

The present embodiment provides a specific form of the call result. The call success rate of the call relation corresponding to the call data can be stored as the call result within the unit time period, so that when counting the call success rate within the query time period, the call success rate within the query time period can be obtained by averaging or the like.

In one of the embodiments, the aforementioned preprocessing includes counting the number of times that the callee is called. On the basis that the method includes the aforementioned step S101, the aforementioned step S102 of the method of storing data further includes the following steps (1) and step (2).

In step (1), the calle identifier carried in the call data is acquired.

According to an example of the embodiment, the callee identifier can be an IMEI (International Mobile Equipment Identity) code of the callee device, or can be a predetermined code that can represent the uniqueness of the callee device negotiated by the application end or the local end and the callee device.

In step (2), the number of times that the same callee identifier appears within the unit time period is counted according to the acquired callee identifier.

In this embodiment, the aforementioned step S103 is further as follow.

The counted number of times that the callee identifier appears, the start time and the end time of the unit time period are simultaneously stored.

A using scenario according to the present embodiment can refer to the using scenario in aforementioned step S204, and details are not described herein again.

This embodiment provides another specific form of the call result. The number of times that the callee identifier appears can be stored as the call result within unit time period, so that when counting the number of times within the query time period, the number of times that the callee device corresponding to the callee identifier within the query time period can be obtained by summing.

According to an example of the embodiment, the labels of the foregoing steps S101 to S303 are not intended to limit the sequence of the steps in the embodiment, and the serial number of each step is only for the convenience of referring to a specific step by referring to the labels thereof when describing. For example, the aforementioned step S203 can be performed before the step S303 or after the step S303, as long as the execution order of the respective steps does not affect the logical relationship of the embodiment.

FIG. 4 is a block diagram of an exemplary structure of a device of storing data according to an embodiment of the present application. Hereinafter, a device of storing data according to an embodiment of the present disclosure is described in detail with reference to FIG. 4. As shown in FIG. 4, the device 10 of storing data specifically includes:

a data acquiring module 11, which is used for acquiring call data obtained in a unit time period;

a preprocessing module 12, which is used for preprocessing the call data based on a preset processing rule according to information carried by the call data;

a storing module 13, which is used for simultaneously storing a pre-processed call data, a start time and an end time of the unit time period.

A call result of the call data, for example, a data message transmitted in a specific protocol format, can be set differently according to requirements of querying, counting, and the like of a database in a later stage. For example, when a call success rate is required to be counted in an actual use, the call result here can be a counted success rate of a call relation corresponding to the call data. When it is required to query the number of times that the application end or the local end device initiate a request in the later stage, the call result can be a counted number of times that the application end initiates the request. When it is required to query the number of times that the same peer end device is called in the later stage, the call result here can be a counted number of times that a callee device corresponding to the same callee identifier is called, etc.

Accordingly, when counting the call results via the method of storing data according to the present embodiment, it only requires to perform simple accumulation or other operations on the call result within the processed unit time period, so that when performing data query or other operations in the later stage, it is not necessary to access a raw data stored in the large database, which improves the data processing efficiency and reduces the load on the database.

In one of the first embodiment, the device 10 of storing data further includes:

a time period receiving module, which is used for receiving an input query time period, and a time length of the query time period is not less than a time length of the unit time period;

a time period acquiring module, which is used for acquiring the unit time period in the query time period according to a start time and an end time of the query time period, the start time and the end time of the unit time period to obtain a query unit time period;

a call result acquiring module, which is used for acquiring call results counted in the query unit time period;

a processing module, which is used for merging the acquired call result; and

an outputting module, which is used for outputting a merged call result.

The aforementioned query time period is generally input by a programmer or other user, and the user can query the call result within a time interval that is to be searched by inputting the query time period. In order to avoid the system from making an error in the query, the time length of the query time period is required to be greater than or equal to the time length of the unit time period.

According to an example of the embodiment, an output manner of the call result can be of various types, it can be output by displaying on a display of an the application end or the local end, or be transmitted to other devices to allow other devices to output, and it can also be output by voice broadcast. The specific output manner is not limited here.

In one of the embodiments, the aforementioned preprocessing module further includes:

a status code acquiring unit, which is used for acquiring a status code indicating that a corresponding call relation is successfully called in the call data, according to the information carried by the call data;

a calculating unit, which is used for calculating a call success rate of the call relation according to the number of the extracted call relation and the number of the status codes.

This example provides a specific form of the call result. The call success rate of the call relation corresponding to the call data can be stored as the call result within the unit time period, so that when counting the call success rate within the query time period, the call success rate within the query time period can be obtained by averaging or the like.

The aforementioned call relation is uniquely determined according to a caller identifier, a callee identifier, and a call timestamp carried in the corresponding call data. The aforementioned information includes the caller identifier, the callee identifier, and the call timestamp. The device of storing data further includes:

an identifier acquiring unit, which is used for acquiring the caller identifier, the callee identifier, and the call timestamp carried by the call data;

a relation determining unit, which is used for uniquely determining the call relation according to the caller identifier, the callee identifier, and the call timestamp.

The aforementioned identifier acquiring unit is specifically used for acquiring the callee identifier carried in the call data.

In one embodiment, the aforementioned preprocessing module further includes:

a number of times counting unit, which is used for counting the number of times that a same callee identifier appears in the unit time period according to the acquired callee identifier.

The callee identifier can be an IMEI (International Mobile Equipment Identity) code of the called device, or can be a predetermined code negotiated by the application end or the local end and the callee device, that can represent the uniqueness of the callee device.

This example provides another specific form of the call result. The number of times that the callee identifier appears can be stored as the call result within unit time period, so that when counting the number of times within the query time period, the number of times that the callee device corresponding to the callee identifier within the query time period can be obtained by summing.

In one of the embodiments, the device of storing data further includes:

a splitting unit, is used for splitting the acquired call data into a plurality of tasks in units of call relations;

a task adding unit, which is used for adding the task to into a queue;

a thread enabling unit, which is used for enabling multiple threads to simultaneously process the tasks in the queue, thereby speeding up the processing speed of data.

Each module included in the above-described device of storing data can be implemented in whole or in part by software, hardware or a combination thereof. Further, each module in the device of storing data can be a program segment for implementing a corresponding function.

Each module in the device of storing data can be implemented in whole or in part by software, hardware, and combinations thereof. The network interface can be an Ethernet card or a wireless network card. Each of the above modules can be of hardware form embedded in or separately from a processor, or be of software form stored in a memory of a server, so that the processor calls to perform operations corresponding to the above modules. The processor can be a central processing unit (CPU), a microprocessor, a microcontroller, or the like.

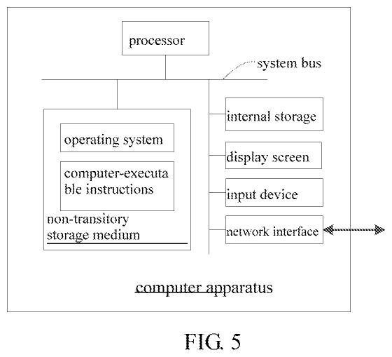

The above-described device of storing data can be embodied in the form of a computer-executable instruction that can be executed on a computer apparatus as shown in FIG. 5.

The computer apparatus according to an embodiment of the present application includes a memory, a processor, and computer-executable instructions stored on the memory and executed by the processor. The processor executes the program to implement the above-described method of storing data.

FIG. 5 is a block diagram of the computer apparatus according to an embodiment of the present application. The computer apparatus can be a server. Referring to FIG. 5, the computer apparatus includes a processor, an internal storage, a non-transitory storage medium, a display screen, an input device, and a network interface coupled via a system bus. The non-transitory storage medium of the computer apparatus can store an operating system and computer-executable instructions, which when executed, can cause the processor to execute a method of storing data of various embodiments of the present application. For the specific implementation process of the method, reference may be made to the specific content of each embodiment in FIG. 1 to FIG. 3, and details are not described herein again. The processor of the computer apparatus is used for providing computing and control capabilities to support an operation of the entire computer apparatus. The internal storage can store computer computer-executable instructions that, when executed by the processor, cause the processor to perform the method of storing data. The input device of the computer apparatus is used for inputting of various parameters. The display screen of the computer apparatus is used for displaying, and the network interface of the computer apparatus is used for network communication. It will be understood by those skilled in the art that the structure shown in FIG. 5 is only a block diagram of a part of the structure related to the solution of the present application, and does not constitute a limitation of the computer apparatus to which the solution of the present application is applied. The specific computer apparatus can includes more or fewer components than those shown in the figures, or combine some components, or have different component arrangements.

A computer-executable storage medium according to an embodiment of the present application stores computer-executable instructions that, when executed by a processor, implement the steps in the foregoing method of storing data.

Any reference to a memory, storage, database, or other medium as used herein can include non-transitory. Suitable non-transitory memories can include read only memory (ROM), programmable ROM (PROM), electrically programmable ROM (EPROM), electrically erasable programmable ROM (EEPROM), or flash memory.

In this embodiment, prior to storing the data, the data is preprocessed in units of time periods according to requirements of subsequent queries, and the preprocessed results and corresponding unit time are simultaneously stored, so that when it is required to query or calculate in the later stage according to the call data stored in the database, it only requires to simply combine the call result stored in the unit time period without accessing all the data stored in the large database again, so as to achieve the goal of improving the data processing efficiency, therefore shortening the time of data query and data processing.

According to an example of the embodiment, all or part processes of the method in the foregoing embodiment can be implemented by relevant hardware instructed by computer-executable instructions. The program can be stored in a computer-executable storage medium, for example in the embodiments of the present application, the program can be stored in a storage medium of the computer system, and executed by at least one processor in the computer system to implement a process including forgoing embodiments of the method. The storage medium includes, but is not limited to, a magnetic disk, a USB flash drive, an optical disk, and the like.

Each technical feature in foregoing embodiments can be combined casually. In order to make the description simple, all other possible combinations of the technical features in the foregoing embodiments are not described. However, as long as there is no conflict between the technical features of the embodiments in other possible combinations, they should be considered as the scope of this manual.

The aforementioned embodiments merely present several embodiments of the present disclosure, which are described specifically and in detail but should not be interpreted as limit to the scope of the present disclosure. It should be noted that those skilled in the art may make various modifications and improvements without departing from the concept of the present disclosure, all of which fall in the protection scope of the present disclosure. Therefore, the protection scope of the present disclosure shall be subject to the appended claims.

What is claimed is:

1. A method of storing data, comprising:
acquiring call data obtained in a unit time period;
preprocessing the call data based on a preset processing rule according to information carried by the call data; and
storing a pre-processed call data, a start time and an end time of the unit time period simultaneously.

2. The method according to claim 1, further comprising:
receiving an input query time period, a time length of which being no less than a time length of the unit time period;
acquiring the unit time period in the inquiry time period according to a start time and an end time of the query time period, the start time and the end time of the unit time period, thus obtaining a query unit time period;
acquiring call results counted in the query unit time period;
merging the acquired call results; and
outputting the merged call result.

3. The method according to claim 1, wherein the step of preprocessing the call data based on a preset processing rule according to information carried by the call data comprises:
acquiring a status code in the call data, which indicates that a corresponding call relation is successfully called according to the information carried by the call data;
calculating a call success rate of the call relation according to the number of the extracted call relations and the number of the status codes.

4. The method according to claim 3, wherein the information comprises a caller identifier, a callee identifier, and a call timestamp, the method further comprises:
acquiring the caller identifier, the callee identifier, and the call timestamp carried by the call data;
determining the call relation uniquely according to the caller identifier, the callee identifier, and the call timestamp.

5. The method according to claim 1, wherein the step of preprocessing the call data based on a preset processing rule according to information carried by the call data comprises:
acquiring a callee identifier carried by the call data;
counting the number of times that the same callee identifier appears in the unit time period according to the acquired callee identifier.

6. A device of storing data, comprising:
a data acquiring module configured to acquire call data obtained in a unit time period;
a preprocessing module configured to preprocess the call data based on a preset processing rule according to information carried by the call data; and
a storing module configured to store the preprocessed call data, a start time and an end time of the unit time period simultaneously.

7. The device according to claim 6, further comprising:
a time period receiving module configured to receive an input query time period, a time length of which being no less than a time length of the unit time period;
a time period acquiring module configured to acquire the unit time period in the query time period according to a start time and an end time of the query time period, the start time and the end time of the unit time period to obtain a query unit time period;
a call result acquiring module configured to acquire call results counted in the query unit time period;
a processing module configured to merge the acquired call results; and
an outputting module configured to output the merged call result.

8. The device according to claim 6, wherein the preprocessing module comprises:
a status code acquiring unit configured to acquire a status code in the call data, which indicates that a corresponding call relation is successfully called, according to the information carried by the call data;
a calculating unit configured to calculate a call success rate of the call relation according to the number of the extracted call relations and the number of the status codes.

9. The device according to claim 6, wherein the information comprises a caller identifier, a callee identifier, and a call timestamp; and the device further comprises:
an identifier acquiring unit configured to acquire the caller identifier, the callee identifier, and the call timestamp carried by the call data;
a relation determining unit configured to determine the call relation uniquely according to the caller identifier, the callee identifier, and the call timestamp.

10. The device according to claim 6, wherein the preprocessing module is further configured to acquire a callee identifier carried by the call data and count the number of times that the same callee identifier appears in the unit time period according to the acquired callee identifier.

11. A computer apparatus, comprising one or more processors, and a memory storing computer-executable instructions, which, when executed by the one or more processors cause the one or more processors to perform steps comprising:
acquiring call data obtained in a unit time period;
preprocessing the call data based on a preset processing rule according to information carried by the call data; and
storing a pre-processed call data, a start time and an end time of the unit time period simultaneously.

12. The computer apparatus according to claim 11, wherein the processor further performs the following steps:
receiving an input query time period, a time length of which being no less than a time length of the unit time period;
acquiring the unit time period in the inquiry time period according to a start time and an end time of the query time period, the start time and the end time of the unit time period, thus obtaining a query unit time period;
acquiring call results counted in the query unit time period;
merging the acquired call results; and
outputting the merged call result.

13. The computer apparatus according to claim 11, wherein the step of preprocessing the call data based on a preset processing rule according to information carried by the call data comprises:
acquiring a status code in the call data, which indicates that a corresponding call relation is successfully called according to the information carried by the call data;
calculating a call success rate of the call relation according to the number of the extracted call relations and the number of the status codes.

14. The computer apparatus according to claim 13, wherein the information comprises a caller identifier, a callee identifier, and a call timestamp, the processor further performs the following steps:
acquiring the caller identifier, the callee identifier, and the call timestamp carried by the call data;
determining the call relation uniquely according to the caller identifier, the callee identifier, and the call timestamp.

15. The computer apparatus according to claim 11, wherein the step of preprocessing the call data based on a preset processing rule according to information carried by the call data comprises:
acquiring a callee identifier carried by the call data;
counting the number of times that the same callee identifier appears in the unit time period according to the acquired callee identifier.

16. At least one non-transitory computer-readable storage medium comprising computer-readable instructions, which, when executed by one or more processors, cause the one or more processors to perform steps comprising:
acquiring call data obtained in a unit time period;
preprocessing the call data based on a preset processing rule according to information carried by the call data; and
storing a pre-processed call data, a start time and an end time of the unit time period simultaneously.

17. The storage medium according to claim 16, wherein the processor further performs the following steps:
receiving an input query time period, a time length of which being no less than a time length of the unit time period;
acquiring the unit time period in the inquiry time period according to a start time and an end time of the query time period, the start time and the end time of the unit time period, thus obtaining a query unit time period;
acquiring call results counted in the query unit time period;
merging the acquired call results; and
outputting a merged call result.

18. The storage medium according to claim 16, wherein the step of preprocessing the call data based on a preset processing rule according to information carried by the call data comprises:
acquiring a status code in the call data, which indicates that a corresponding call relation is successfully called according to the information carried by the call data;
calculating a call success rate of the call relation according to the number of the extracted call relations and the number of the status codes.

19. The storage medium of claim 18, wherein the information comprises a caller identifier, a callee identifier, and a call timestamp, the processor further performs the following steps:
acquiring the caller identifier, the callee identifier, and the call timestamp carried by the call data;
determining the call relation uniquely according to the caller identifier, the callee identifier, and the call timestamp.

20. The storage medium according to claim 16, wherein the step of preprocessing the call data based on a preset processing rule according to information carried by the call data comprises:
acquiring a callee identifier carried by the call data;
counting the number of times that the same callee identifier appears in the unit time period according to the acquired callee identifier.
